(19) United States
(12) Patent Application Publication
(10) Pub. No.: US 2024/0089589 A1
(43) Pub. Date: Mar. 14, 2024

(54) CONTROL DEVICE AND RECORDING MEDIUM

(71) Applicant: Morpho, Inc., Tokyo (JP)

(72) Inventors: Masaki SATOH, Tokyo (JP); Kazuhiro HIRAMOTO, Tokyo (JP)

(73) Assignee: Morpho, Inc., Tokyo (JP)

(21) Appl. No.: 18/274,209

(22) PCT Filed: Jan. 14, 2022
(86) PCT No.: PCT/JP2022/001108

§ 371 Date: Jul. 25, 2023

(30) Foreign Application Priority Data
Jan. 27, 2021 (JP) 2021-011557

(51) Int. Cl. H04N 23/63; H04N 23/667

(52) U.S. Cl. CPC H04N 23/635; H04N 23/667

(57) ABSTRACT

Proposed is a technique for providing assistance so that an image is captured with the intended composition. An image processing device according to the present invention includes a correction means capable of carrying out image blur correction, and can output an image generated on the basis of a cut-out region which has been cut out from an image based on imaging performed by an imaging device. The image processing device includes a control means for controlling notification related to a range from which the cut-out region can be cut out while the image blur correction performed by the correction means is activated.

### TECHNICAL FIELD

The present invention relates to an image processing device and the like.

### RELATED ART

In high-magnification zoom photography, camera shake is often conspicuous in the captured image. For example, when the zoom magnification is increased by digital zoom (electronic zoom), a narrow range on the image sensor is enlarged and displayed so the influence of camera shake becomes more obvious. Patent Literature 1, for example, discloses a camera system that improves the sensitivity of shake correction during zoom photography.

### CITATION LIST

### Patent Literature

[Patent Literature 1] Japanese Patent Application Laid-Open No. 2014-064323

### SUMMARY OF INVENTION

### Technical Problem

In the camera system described in Patent Literature 1, the more the zoom magnification is increased, the more the shake detection amount is increased to reduce the camera shake. However, the camera system described in Patent Literature 1 is based on optical shake correction, and does not mention electronic shake correction.

Furthermore, for the camera system described in Patent Literature 1, for example, when shake correction is used during high-magnification zoom photography, the optical axis is adjusted by the shake correction so there arises a problem that it is difficult for the user to photograph with the intended photographing position (composition). Besides, even with electronic shake correction, for example, the effective pixels which are pixels used for imaging on the image sensor change due to the shake correction, and therefore a similar problem arises.

In view of the above problems, the present invention proposes a technique for providing assistance to capture an image with the intended composition (photographing location).

### Solution to Problem

According to one aspect of the present invention, an image processing device includes a correction means that is capable of performing image blur correction, and is capable of outputting an image generated based on a cut-out region cut out from an image based on imaging performed by an imaging device. The image processing device includes a control means controlling notification related to a range from which the cut-out region is able to be cut out while the image blur correction performed by the correction means is activated.

### Effects of Invention

According to the information processing device of the present invention, an effect of being able to provide assistance to capture an image with the intended composition is achieved.

### BRIEF DESCRIPTION OF DRAWINGS

FIG. 1 is a block diagram showing an example of the functional configuration of the image processing device.

FIG. 2 is a flowchart showing an example of the flow of the image processing.

FIG. 3 is a diagram showing a specific example of the correction vector and the guide indicator.

FIG. 4 is a diagram showing a specific example of the image after each process associated with displacement of the imaging unit.

FIG. 5 is a diagram showing a specific example of the image after each process associated with displacement of the imaging unit.

FIG. 6 is a diagram showing a specific example of the image after each process associated with displacement of the imaging unit.

FIG. 7 is a diagram showing an example of transition of the through image associated with displacement of the imaging unit.

FIG. 8 is a block diagram showing an example of the functional configuration of the smartphone.

FIG. 9 is a flowchart showing an example of the flow of the image capturing processing.

FIG. 10 is a flowchart showing an example of the flow of the shake correction mode setting process.

FIG. 11 is a diagram showing another example of the zoom position indicator in a modified example.

FIG. 12 is a diagram showing an example of transition of the through image associated with displacement of the imaging unit in a modified example.

FIG. 13 is a diagram showing another example of the guide indicator in a modified example.

FIG. 14 is a diagram showing an example of the recording medium.

### DESCRIPTION OF EMBODIMENTS

Hereinafter, an exemplary embodiment for implementing the present invention will be described with reference to the drawings. In the description of the drawings, the same elements may be denoted by the same reference numerals, and redundant description may be omitted. In addition, the components described in this embodiment are merely examples, and are not intended to limit the scope of the present invention.

### Embodiment

An example of the embodiment for realizing the image processing technology, the image capturing technology, etc. of the present invention will be described below.

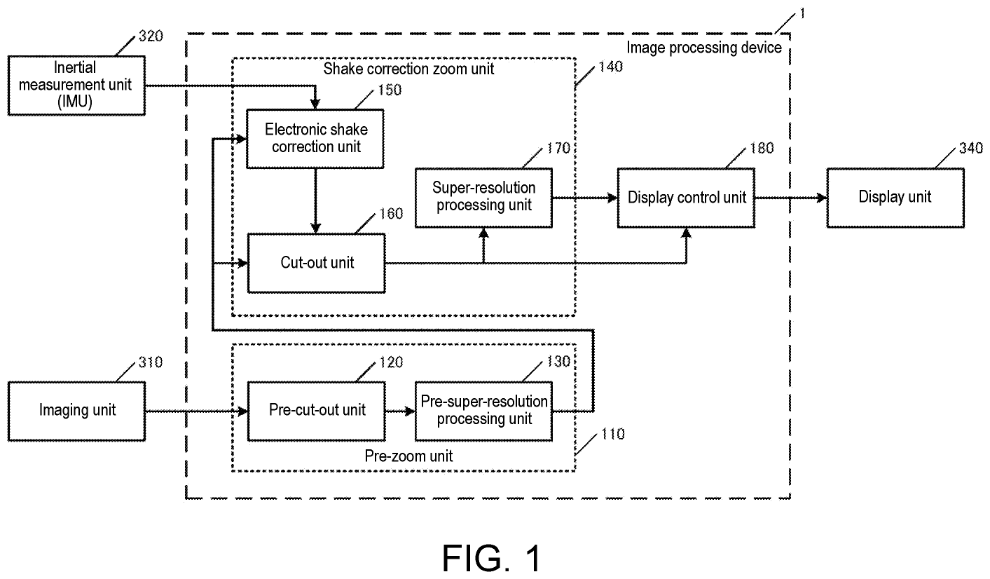

FIG. 1 is a block diagram showing an example of the functional configuration of an image processing device 1 according to one aspect of this embodiment. The image processing device 1 may be called an image capturing device or an image output device. The image processing device 1 includes, for example, a pre-zoom unit 110, a shake correction zoom unit 140, and a display control unit 180. The pre-zoom unit 110 includes, for example, a pre-cut-out unit 120 and a pre-super-resolution processing unit 130. Further, the shake correction zoom unit 140 includes, for example, an electronic shake correction unit 150, a cut-out unit 160, and a super-resolution processing unit 170. These are, for example, functional units (functional blocks) included in a processing unit (processing device) and a control unit (control device) (not shown) of the image processing device 1, and have processors such as CPU and DSP, and integrated circuits such as ASIC.

The pre-cut-out unit 120 receives, for example, an image (hereinafter referred to as “image sensor image”) captured by the imaging unit 310 outside the image processing device 1 as input.

The pre-cut-out unit 120 has, for example, a function of cutting out a predetermined region in the central part of the image sensor image based on a preset pre-zoom magnification and the input image sensor image. The image cut out by the pre-cut-out unit 120 is referred to as “pre-cut-out image” hereinafter.

The pre-super-resolution processing unit 130 has, for example, a function of applying super-resolution processing for improving image resolution to the input pre-cut-out image and outputting the same as a pre-zoom image. The pre-super-resolution processing unit 130 may execute image distortion correction processing in addition to the super-resolution processing. The image distortion correction processing may include, for example, rolling shutter distortion correction processing and wide-angle distortion correction processing.

That is, the pre-zoom unit 110 has, for example, a function of outputting the pre-zoom image obtained by enlarging (digitally zooming) the central part of the input image sensor image by a predetermined pre-zoom magnification (for example, “p” times (“p” is an arbitrary constant greater than 1)).

The electronic shake correction unit 150 receives, for example, a plurality of frames of pre-zoom images (hereinafter referred to as “pre-zoom image group”) as input. Further, the electronic shake correction unit 150 may, for example, additionally receive inertial information acquired by an inertial measurement unit (IMU) 320 outside the image processing device 1 as input.

Here, the inertial information refers to, for example, information related to the tilt and translation of the imaging unit 310, and refers to, for example, information related to the tilt of the imaging unit 310 detected by a triaxial gyro sensor in the inertial measurement unit 320 and the translation of the imaging unit 310 detected by an acceleration sensor in the inertial measurement unit 320.

Based on the input pre-zoom image group, the electronic shake correction unit 150 calculates, for example, an optical flow between frames of the pre-zoom image group. Then, the electronic shake correction unit 150 has a function of calculating shake correction conversion (shake correction map) in the transition between frames of the pre-zoom image group based on at least one of the calculated optical flow and the inertial information.

Here, the shake correction conversion refers to conversion for mapping the cut-out region before performing shake correction in the cut-out unit 160 (hereinafter referred to as “pre-correction cut-out region”) to the cut-out region after shake correction (hereinafter referred to as “post-correction cut-out region”). The post-correction cut-out region is, for example, a convenient cut-out region corresponding to the pre-correction cut-out region, which is obtained as a result of applying the shake correction conversion to the pre-zoom image input to the cut-out unit 160, and is a cut-out region when shake correction is applied.

When the shake correction conversion is all processed as image rotation, the shake correction conversion may be represented by a quaternion, which makes it possible to achieve high-speed processing.

The cut-out unit 160 has, for example, a function of cutting out a predetermined region near the central part of the pre-zoom image based on a preset shake correction zoom magnification, the shake correction conversion calculated by the electronic shake correction unit 150, and the input pre-zoom image. The image that has been cut out is referred to as “cut-out image” hereinafter.

Further, the cut-out unit 160 has, for example, a function of calculating a correction vector C, which will be described later, based on the post-correction cut-out region.

The super-resolution processing unit 170 has, for example, a function of applying super-resolution processing for improving image resolution to the input cut-out image and outputting the same as a zoom image.

That is, the shake correction zoom unit 140 has, for example, a function of outputting the zoom image obtained by enlarging (digitally zooming) the vicinity of the center of the pre-zoom image by a predetermined shake correction zoom magnification (for example, “q” times (“q” is an arbitrary constant equal to or greater than 1)). Furthermore, the shake correction zoom unit 140 has a function of performing electronic shake correction on the zoom image when a shake correction condition, which will be described later, is satisfied.

For example, by combining the pre-zoom unit 110 set to the pre-zoom magnification of “p” times and the shake correction zoom unit 140 set to the shake correction zoom magnification of “q” times, the resulting zoom image is an ultra-zoomed image in which the vicinity of the center of the image sensor image is super-enlarged (p×q) times.

The display control unit 180 receives, for example, the zoom image and the correction vector C corresponding to the zoom image as input.

The display control unit 180 has, for example, an indicator generation function of generating a guide indicator, which will be described later, based on the correction vector C. Also, the display control unit 180 has, for example, a through image generation function of combining the generated guide indicator and the input zoom image to generate a through image.

The display unit 340 has, for example, a function of displaying the through image when receiving the through image generated by the display control unit 180 as input.

Here, “display” of an image is a kind of “output” of the image. The “output” of the image may include, for example, output (internal output) of the image to other functional units in the device itself, output (external output) or transmission (external transmission) of the image to devices (external devices) other than the device itself, etc., in addition to display (display output) of the image on the device itself.

### [Procedure of Image Processing]

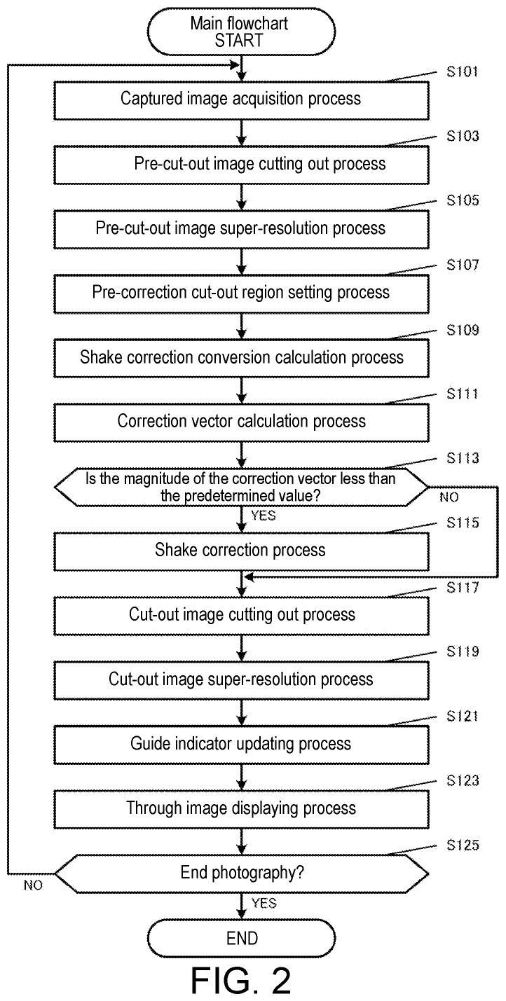

FIG. 2 is a flowchart showing an example of the procedure of image processing in this embodiment. The processing in the flowchart of FIG. 2 is realized by, for example, the processing unit of the image processing device 1 reading the codes of a camera application program stored in a storage unit (not shown) into a RAM (not shown) and executing the codes.

Each symbol S in the flowchart of FIG. 2 means a step. Further, the flowchart described below merely shows an example of the procedure of image processing in this embodiment, and of course, other steps may be added or some steps may be deleted.

First, the pre-cut-out unit 120 performs a captured image acquisition process (S101). Specifically, for example, an image sensor image captured by the imaging unit 310 is received. The pre-cut-out unit 120 may collectively receive image sensor images of captured “N” frames (“N” is an arbitrary integer equal to or greater than 1) as an image sensor image group.

Next, the pre-cut-out unit 120 performs a pre-cut-out image cutting out process (S103). Specifically, for example, a pre-cut-out region is set based on the pre-zoom magnification, and the image sensor image within the pre-cut-out region is output as a pre-cut-out image. When the image sensor image group is input, the step of S103 may be repeated for each frame of the image sensor image group to generate the pre-cut-out image group of “N” frames.

For example, when the number of pixels of the image sensor image is “x” pixels and the pre-zoom magnification is “p” times, the pre-cut-out unit 120 sets, for example, a region of “x/p²” pixels in the central part of the image sensor image as the pre-cut-out region. Then, the pre-cut-out unit 120 outputs the image sensor image within the pre-cut-out region as the pre-cut-out image.

Then, the pre-super-resolution processing unit 130 performs a pre-cut-out image super-resolution process (S105). Specifically, for example, the pre-cut-out image is subjected to super-resolution processing and output as a pre-zoom image.

For example, in the super-resolution processing function, the pre-super-resolution processing unit 130 performs super-resolution processing that sets the image resolution to, for example, “p” times on the pre-cut-out image of “x/p²” pixels, and outputs the obtained image of “x” pixels as the pre-zoom image.

The pre-super-resolution processing unit 130 may perform super-resolution processing at a magnification different from the pre-zoom magnification. In this case, the sizes (numbers of pixels) of the image sensor image and the pre-zoom image are different. Furthermore, when the pre-cut-out image group is input, the pre-super-resolution processing unit 130 may perform super-resolution processing using spatial information of the image within each frame and temporal information of the image between the frames.

In addition, the pre-zoom unit 110 may perform super-resolution processing on the image sensor image in the pre-super-resolution processing unit 130, and then crop the super-resolved image in the pre-cut-out unit 120 to output the pre-zoom image.

When the pre-zoom image of the “t”^{th} frame (“t” is an arbitrary natural number) is input to the cut-out unit 160, the cut-out unit 160 performs a pre-correction cut-out region setting process (S107). Specifically, for example, the zoom cut-out region of the “t−1”^{th} frame is set as the pre-correction cut-out region of the “t”^{th} frame. In the first frame, which is the head frame, the pre-correction cut-out region is set to, for example, a rectangular region for cutting (digitally zooming) the center of the pre-zoom image at the shake correction zoom magnification of “q” times.

Next, based on the input pre-zoom image of the “t”^{th} frame and the pre-zoom image of the “t−1”^{th} frame, the electronic shake correction unit 150 calculates a local motion vector (for example, optical flow) in a local image element in the pre-zoom image using, for example, the Lucas-Kanade method. Then, based on the calculated local motion vector, the electronic shake correction unit 150 calculates the shake correction conversion corresponding to the parallel movement/rotational movement (shake) of the imaging unit 310 occurring between the “t−1”^{th} frame and the “t”^{th} frame (S109). In the first frame, which is the head frame, the shake correction conversion can be, for example, identity mapping.

The electronic shake correction unit 150 may calculate the shake correction conversion based on the inertial information acquired by the inertial measurement unit 320 without using the pre-zoom image group.

Furthermore, the electronic shake correction unit 150 may calculate the inertial information based on the input pre-zoom image of the “t”^{th} frame and the pre-zoom image of the “t−1”^{th} frame, and calculate the shake correction conversion based on the calculated inertial information. At this time, the electronic shake correction unit 150 may also use the inertial information acquired by the inertial measurement unit 320 as, for example, an initial value to calculate (recalculate) inertial information from the pre-zoom image group.

In addition, the electronic shake correction unit 150 is not limited to calculating the shake correction conversion based on the pre-zoom image group of two adjacent frames in the time axis direction. For example, at least one of the optical flow and the inertial information may be calculated based on a pre-zoom image group composed of any “L” frames (L is an arbitrary positive integer) that are consecutive on the time axis, and the shake correction conversion between adjacent frames in the time axis direction of the pre-zoom image group may be calculated.

When acquiring the shake correction conversion from the “t−1”^{th} frame to the “t”^{th} frame from the electronic shake correction unit 150, the cut-out unit 160 calculates the post-correction cut-out region of the “t”^{th} frame based on the pre-correction cut-out region of the “t”^{th} frame and the shake correction conversion.

Then, the cut-out unit 160 performs a correction vector calculation process (S111). Specifically, for example, the center position (for example, position of the center of gravity) of the post-correction cut-out region is calculated as a correction position. Then, for example, a correction vector C with the center position of the pre-zoom image as the starting point and the correction position as the ending point is calculated (S111).

If the lengths in the longitudinal direction and the transverse direction in the pre-zoom image are not equal, the cut-out unit 160 may calculate the correction vector C by calculating the correction position in which the length is normalized to the length in the longitudinal direction or the transverse direction.

Alternatively, after calculating the correction vector C, the magnitude of the correction vector C may be normalized according to the lengths in the longitudinal direction and the transverse direction in the pre-zoom image.

When the correction vector C is calculated by the correction vector calculation process, the cut-out unit 160 determines whether the magnitude of the correction vector C (for example, L2 norm) is smaller than a predetermined value “R” (“R” is a positive constant) (less than a predetermined value) (S113). This determination condition is called “shake correction condition.”

It is possible to set the predetermined value “R” of the shake correction condition, for example, so that the post-correction cut-out region does not protrude from the pre-zoom image.

In this step, the cut-out unit 160 may determine whether the magnitude of the correction vector C is equal to or less than the predetermined value “R.”

If the magnitude of the correction vector C is less than the predetermined value “R” (S113: YES), the shake correction condition is satisfied. Therefore, the cut-out unit 160 sets the post-correction cut-out region of the “t”^{th} frame as the zoom cut-out region, as a shake correction process (S115).

If the magnitude of the correction vector C is equal to or greater than the predetermined value “R” (S113: NO), the shake correction condition is not satisfied. Therefore, the cut-out unit 160 does not execute the step of S115, and sets the pre-correction cut-out region of the “t”^{th} frame directly as the zoom cut-out region. Also, the cut-out unit 160 restores (updates) the correction vector C of the “t”^{th} frame to the correction vector C of the “t−1”^{th} frame.

When the shake correction condition is not satisfied, the cut-out unit 160 may set the zoom cut-out region to, for example, the central region of the pre-zoom image.

Then, the cut-out unit 160 performs a cut-out image cutting out process (S117). Specifically, for example, the pre-zoom image within the zoom cut-out region is output as a cut-out image based on the set zoom cut-out region.

Then, the super-resolution processing unit 170 performs a cut-out image super-resolution process (S119). Specifically, for example, the cut-out image is subjected to super-resolution processing and output as a zoom image.

The super-resolution processing unit 170 may perform image distortion correction processing in addition to the super-resolution processing. The image distortion correction processing may include, for example, rolling shutter distortion correction processing and wide-angle distortion correction processing. In addition, the super-resolution processing unit 170 may acquire the shake correction conversion from the electronic shake correction unit 150 or the cut-out unit 160, and perform processing in consideration of the shake correction conversion in the super-resolution processing. Further, when a cut-out image group composed of cut-out images of a plurality of frames is input, the super-resolution processing unit 170 may perform super-resolution processing in consideration of the time axis direction.

The shake correction zoom unit 140 may perform super-resolution processing on the pre-zoom image in the super-resolution processing unit 170, and then crop the super-resolved image in the cut-out unit 160 to output the zoom image.

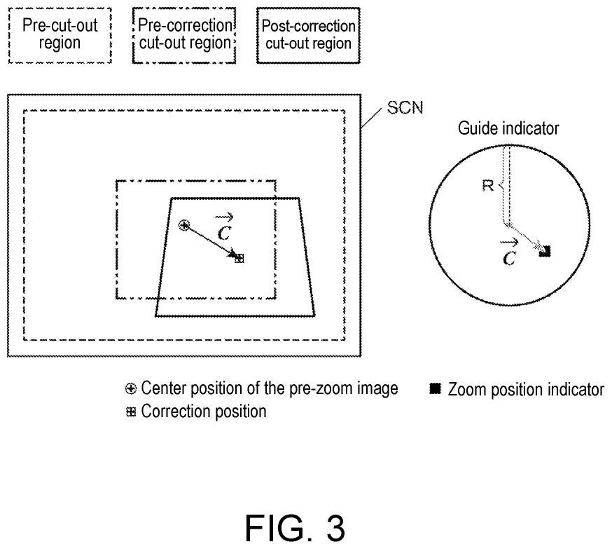

For example, when acquiring the correction vector C of the “t”^{th} frame from the cut-out unit 160, the display control unit 180 performs a guide indicator updating process (S121). Specifically, for example, the guide indicator is updated (generated) based on the acquired correction vector C and the predetermined value “R” of the shake correction condition. FIG. 3 shows an example of the guide indicator generated by the correction vector C.

On the left side of FIG. 3, the center position of the pre-zoom image, which is the center point (point of the center of gravity) of the pre-cut-out region indicated by the dashed line in the full view SCN, is indicated by a cross mark in a circle. Further, the post-correction cut-out region calculated based on the pre-correction cut-out region indicated by a two-dot chain line and the shake correction conversion is shown as a solid-line quadrilateral region (the trapezoidal region in the drawing). Then, the correction position, which is the center point (point of the center of gravity) of the post-correction cut-out region, is indicated by a cross mark in a square. At this time, the correction vector C before normalization is a vector that takes the center position of the pre-zoom image as the starting point and the correction position as the ending point. The correction vector C input to the display control unit 180 is, for example, a vector obtained by normalizing the correction vector C before normalization according to the lengths of the pre-cut-out region in the longitudinal direction and the transverse direction.

An example of the guide indicator generated by the correction vector C which is input to the display control unit 180 is shown on the right side of FIG. 3. The guide indicator is composed of, for example, a circular outer edge whose radius is the predetermined value “R” of the shake correction condition, and a zoom position indicator indicated by a black square. On the right side of FIG. 3, for convenience, the center position of the outer edge of the guide indicator is indicated by a gray circle mark.

When arranging the starting point of the correction vector C at the center position of the outer edge of the guide indicator, the zoom position indicator is arranged, for example, as a square with the ending point of the correction vector C as the center position. The length “Z” of one side of the zoom position indicator can be, for example, an arbitrary value that is sufficiently small with respect to “R” (for example, “Z=R/20”).

That is, the position of the zoom position indicator within the outer edge of the guide indicator corresponds to the position of the zoom cut-out region relative to the pre-cut-out region.

Since the magnitude of the correction vector C is less than “R,” the ending point of the correction vector C does not exceed the outer edge of the guide indicator. Therefore, the zoom position indicator does not extend far beyond the outer edge.

For example, the radius of the outer edge may be set to “R′” calculated by “R′=R+Z/sqrt(2)” so that the square zoom position indicator does not exceed the outer edge of the guide indicator. “sqrt(x)” is the square root of “x.”

Returning to FIG. 2, when acquiring the zoom image of the “t”^{th} frame from the super-resolution processing unit 170, the display control unit 180 performs a through image displaying process (S123). Specifically, for example, the zoom image of the “t”^{th} frame and the updated guide indicator of the “t”^{th} frame are combined (overlaid) and displayed on the display unit 340 as a through image.

For example, if it is selected to end the photography based on input (user operation) to an operation unit (not shown) (S125: YES), the image processing device 1 ends the processing.

If it is not selected to end the photography (S125: NO), the image processing device 1 returns the processing to the step of S101, for example.

### Specific Example of Image Processing

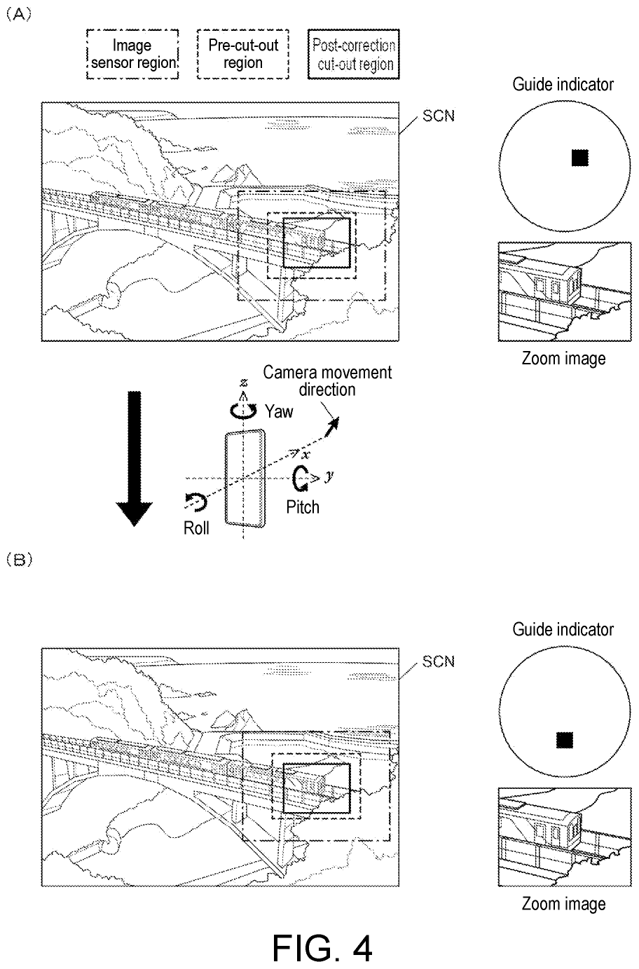

FIG. 4 to FIG. 6 show specific examples of changes in the pre-cut-out region and changes in the zoom cut-out region that are associated with displacement (changes in position/angle) of the imaging unit 310. Specific examples of the guide indicator generated according to the change between frames and the output zoom image are also shown.

In these drawings, the bounding box of the image sensor region cut out as the image sensor image in the full view SCN is indicated by a one-dot chain line, the bounding box of the pre-cut-out region is indicated by a dashed line, the bounding box of the pre-correction cut-out region is indicated by a two-dot chain line, and the bounding box of the post-correction cut-out region is indicated by a solid line. Also, although these bounding boxes are all represented as rectangles for simplicity of description, the bounding boxes are not limited to rectangles in practice.

The full view SCN, for example, depicts a three-car train crossing an arch bridge from left to right. In addition, there are mountains on the left and right of the arch bridge, and a harbor surrounded by embankment is depicted behind the arch bridge. The full view SCN actually extends in all directions, but here a temporary outer frame is provided to show only the inside of the outer frame.

FIG. 4 shows an example of a state in which shake correction is activated in the shake correction zoom unit 140. In (A) of FIG. 4, for example, the image sensor region captures the vicinity of the front end of the leading car of the train in the center. For example, the face of the leading car is captured in the post-correction cut-out region.

The center of the post-correction cut-out region is slightly shifted to the upper right in front view from the center of the pre-cut-out region. Therefore, the zoom position indicator in the guide indicator is displayed slightly shifted to the upper right from the center of the outer edge.

At this time, an image of the face of the leading car crossing the arch bridge and heading for the tunnel, obtained by super-enlarging the vicinity of the center of the image sensor region, is output as the zoom image.

For example, when the orientation of the imaging unit 310 is slightly displaced to the upper right from (A) of FIG. 4 due to the influence of camera shake, each region transitions to, for example, (B) of FIG. 4.

In (B) of FIG. 4, the upper end of the image sensor region captures the back side of the embankment, which is outside the range in (A) of FIG. 4, and the left end of the image sensor region no longer captures the door at the rear part of the leading car, which is included in (A) of FIG. 4. The pre-correction cut-out region is also shifted according to the change in the image sensor region, but the post-correction cut-out region is not displaced from (A) of FIG. 4 because of shake correction conversion.

The center of the post-correction cut-out region is slightly shifted downward from the center of the pre-cut-out region. Therefore, the zoom position indicator in the guide indicator is displayed slightly shifted downward from the center of the outer edge. Since the zoom position indicator is not in contact with the outer edge, shake correction is activated in the shake correction zoom unit 140 in (B) of FIG. 4 as well. At this time, the same zoom image as in (A) of FIG. 4 is output, and no blurring occurs in the zoom image.

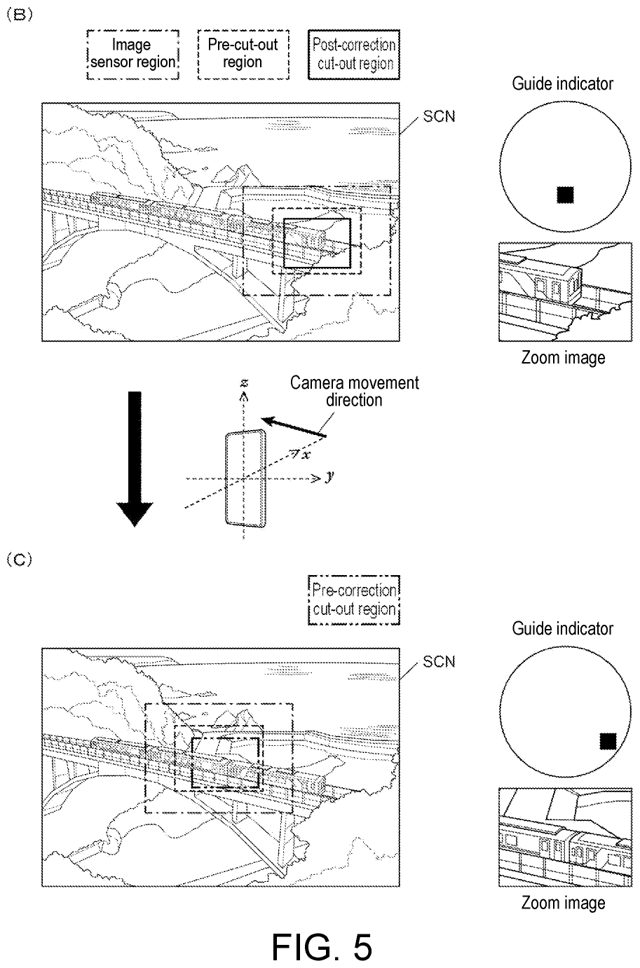

FIG. 5 shows an example of a state in which shake correction is switched to be deactivated in the shake correction zoom unit 140. (B) of FIG. 5 shows the state of (B) of FIG. 4.

From (B) of FIG. 5, for example, the orientation of the imaging unit 310 is slowly swung to the upper left in order to capture an image of the rear of the train. Then, the zoom position indicator moves to the lower right within the outer edge of the guide indicator. However, in a state where the zoom position indicator has not reached the outer edge, shake correction is activated in the shake correction zoom unit 140, and the same zoom image as in (B) of FIG. 5 continues to be acquired. Eventually, when the zoom position indicator reaches the outer edge of the guide indicator, the shake correction condition is no longer satisfied so shake correction is switched to be deactivated in the shake correction zoom unit 140, and the zoom image changes to follow the pre-cut-out image.

(C) of FIG. 5 shows an example of the transition of each region when the orientation of the imaging unit 310 continues to be swung to the upper left. In (C) of FIG. 5, as a result of continuing to swing the orientation of the imaging unit 310 from (B) of FIG. 5 to the upper left, the image sensor region captures the second car of the train. At this time, since the state where the shake correction condition is not satisfied continues, the zoom cut-out region continues to be fixed, for example, at the lower right end within the pre-cut-out region according to the pre-correction cut-out region. Besides, the zoom position indicator continues to be fixed in contact with the lower right end within the outer edge, for example. As a result, the zoom cut-out region follows the vicinity of the center of the image sensor region, and for example, an image near the joint between the leading car and the second car of the train is output as the zoom image.

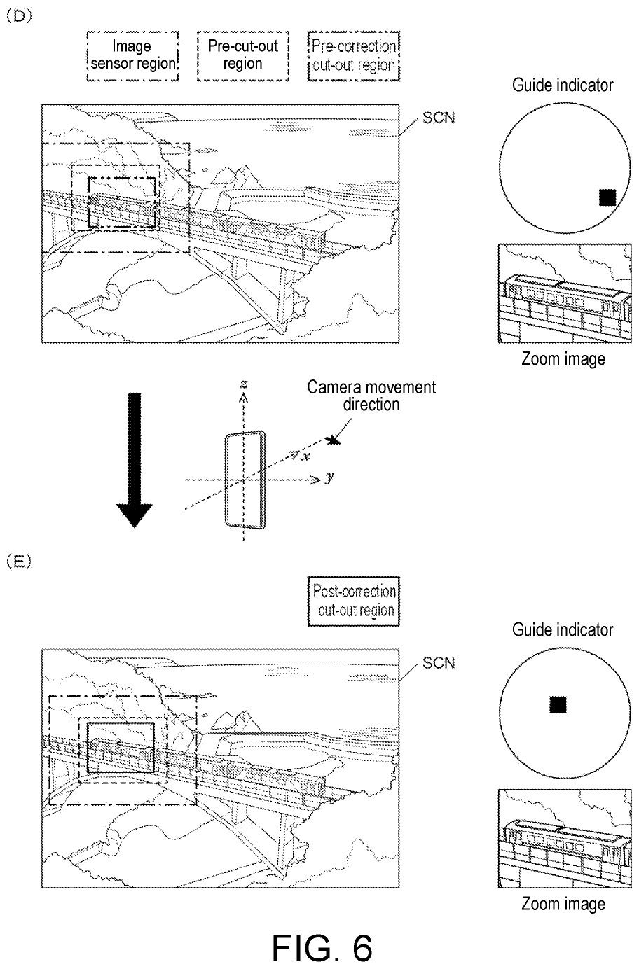

FIG. 6 shows an example of a state in which shake correction is switched to be activated again in the shake correction zoom unit 140. In (D) of FIG. 6, as a result of continuing to swing the orientation of the imaging unit 310 from (C) of FIG. 5 to the upper left, the image sensor region captures the last car of the train in the center. At this time, since the state where the shake correction condition is not satisfied continues, the zoom cut-out region continues to be fixed, for example, at the lower right end within the pre-cut-out region according to the pre-cut-out region. Therefore, the zoom position indicator continues to be fixed in contact with the lower right end within the outer edge, for example. As a result, the zoom cut-out region follows within the pre-cut-out region, and for example, an image of the last car of the train is output as the zoom image.

For example, when the orientation of the imaging unit 310 is slightly displaced to the lower right from (D) of FIG. 6 in order to follow the last car of the train, each region transitions to, for example, (E) of FIG. 6.

In (E) of FIG. 6, the left end of the image sensor region is slightly off to the right from the temporary outer frame of the full view SCN that is in contact in (D) of FIG. 6. The zoom position indicator in the guide indicator is displayed slightly shifted to the upper left from the center of the outer edge. Since the zoom position indicator is not in contact with the outer edge, (E) of FIG. 6 shows that shake correction is activated again in the shake correction zoom unit 140. At this time, the post-correction cut-out region is not displaced from (D) of FIG. 6 because of the shake correction conversion. As a result, the same zoom image as in (D) of FIG. 6 is output, and no blurring occurs in the zoom image in the transition from (D) of FIG. 6 to (E) of FIG. 6.

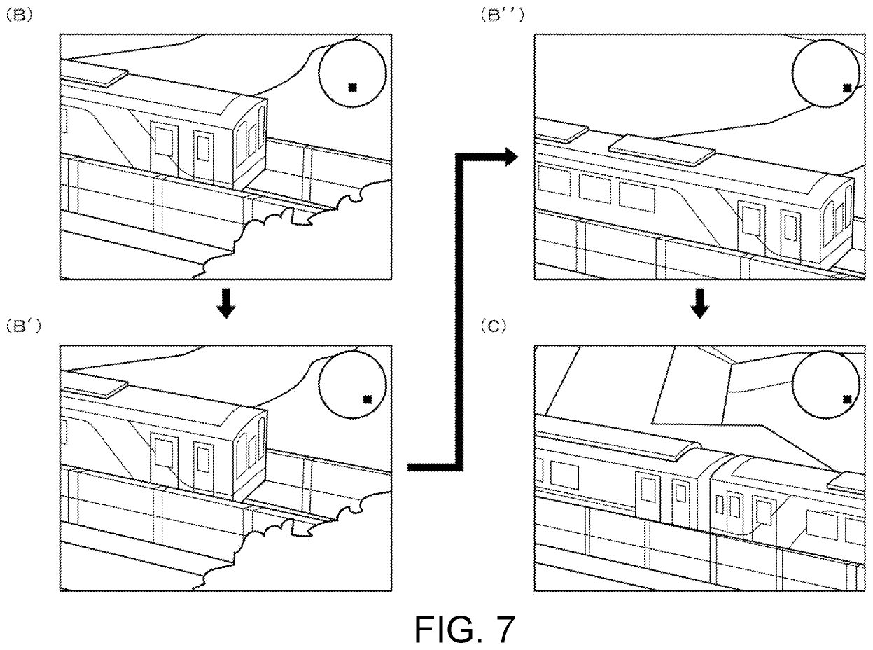

FIG. 7 shows an example of transition of the through image in the process from (B) of FIG. 5 to (C) of FIG. 5. FIG. 7 shows an example of transition of the through image generated, for example, when the guide indicator is combined on the upper right of the zoom image.

Nevertheless, the position where the guide indicator is combined is not limited to the upper right of the zoom image. For example, the position may be the upper left, lower right, or lower left.

(B) of FIG. 7 is an example of the through image corresponding to (B) of FIG. 5. This image shows the face of the leading car of the train captured by digital zoom. Then, since in the guide indicator, the zoom region indicator is displayed near the center of the outer edge, it indicates that shake correction is activated.

(B′) of FIG. 7 is an example of the through image when the orientation of the imaging unit 310 starts to be slowly swung to the upper left from (B) of FIG. 7, for example, in order to capture an image of the rear of the train. In this image, the zoom region indicator has moved in the lower right direction within the outer edge of the guide indicator, symmetrical with the change in the orientation of the imaging unit 310. However, since the zoom region indicator is not in contact with the outer edge, it indicates that shake correction is activated. At this time, despite that the orientation of the imaging unit 310 is changed, shake correction is activated and the zoom image does not change so the operator of the imaging unit 310 may feel strange if there is no guide indicator. However, as it is possible to confirm the position of the zoom region indicator in the guide indicator displayed in the through image, the image processing device 1 is able to notify the operator of the imaging unit 310 that shake correction is activated. Thereby, it is also possible to prevent the operator of the imaging unit 310 who intends to change the imaging region from changing the orientation of the imaging unit 310 more rapidly and acquiring an unintended range as the image sensor image.

(B″) of FIG. 7 is an example of the through image when the orientation of the imaging unit 310 continues to be slowly swung to the upper left from (B′) of FIG. 7. In this image, the zoom region indicator moves further in the lower right direction and comes into contact with the outer edge of the guide indicator. Therefore, the image processing device 1 is able to notify the operator of the imaging unit 310 that shake correction is deactivated. At this time, since the zoom cut-out region starts to move along the orientation of the imaging unit 310, the zoom image starts to move toward the rear of the leading car of the train. Therefore, the operator of the imaging unit 310 can easily grasp that the imaging target acquired as the zoom image changes while the orientation of the imaging unit 310 continues to change in the same direction.

(C) of FIG. 7 is an example of the through image when the orientation of the imaging unit 310 continues to be swung to the upper left, which is the same direction, from FIG. (B″). In this image, the zoom region indicator continues to contact the outer edge of the guide indicator. Therefore, the image processing device 1 is able to notify the operator of the imaging unit 310 that shake correction remains deactivated.

Similarly, when capturing an intended imaging target in the zoom image, the operator of the imaging unit 310 is able to easily grasp that, by holding the imaging unit 310 to slightly return the orientation of the imaging unit 310 in the direction connecting the position of the zoom region indicator from the center of the outer edge in the guide indicator, it is possible to activate shake correction again and continue to properly capture the imaging target as the zoom image.

### [Actions and Effects of the Embodiment]

An image processing device (for example, image processing device 1) in this embodiment includes a correction means (for example, electronic shake correction unit 150) that is capable of performing image blur correction (for example, shake correction), and is capable of outputting an image (for example, zoom image) generated based on a cut-out region (for example, zoom cut-out region) cut out from an image (for example, pre-zoom image) based on imaging performed by an imaging device (for example, imaging unit 310). The image processing device includes a control means (for example, display control unit 180) controlling notification (for example, display of a guide indicator, sound output of a pin sound, etc.) related to a range (for example, range that satisfies a shake correction condition) from which the cut-out region can be cut out while the image blur correction performed by the correction means is activated. According to this, by controlling the notification related to the range from which the cut-out region can be cut out while the image blur correction performed by the correction means is activated, it is possible to provide assistance to capture an image with the intended composition. In addition, by utilizing the notification, it is possible to easily and properly output an image generated based on the cut-out region cut out from the image based on imaging performed by the imaging device.

Further, in this case, the control means (for example, display control unit 180) controls the notification based on displacement (for example, correction vector C) of the cut-out region associated with movement of the imaging device and a set value (for example, predetermined value “R” of the shake correction condition) that defines a range in which the image blur correction is activated. According to this, it is possible to accurately control the notification based on the set value that can affect the displacement of the cut-out region associated with the movement of the imaging device.

Further, in this case, the image processing device further includes an auxiliary information generation means (for example, display control unit 180) generating auxiliary information (for example, guide indicator) which is information based on the displacement (for example, correction vector C) and the set value (for example, predetermined value “R”) and is capable of specifying the range from which the cut-out region can be cut out while the image blur correction is activated (for example, range that satisfies the shake correction condition). According to this, it is possible to generate the auxiliary information that allows the user to easily grasp the range from which the cut-out region can be cut out while the image blur correction is activated.

Further, in this case, the auxiliary information generation means (for example, display control unit 180) generates the auxiliary information (for example, guide indicator) which includes at least an indicator (for example, zoom position indicator) corresponding to a predetermined position (for example, correction position) based on the displacement and an outer edge of the range (for example, outer edge of the guide indicator) from which the cut-out region can be cut out while the image blur correction is activated. The control means (for example, display control unit 180) performs the notification by displaying the auxiliary information on a display device (for example, display unit 340). According to this, the user is able to easily grasp whether the image blur correction is activated by confirming the outer edge and the indicator of the auxiliary information.

Further, in this case, the control means (for example, display control unit 180) changes the position of the indicator (for example, zoom position indicator) included in the auxiliary information (for example, guide indicator) along with a change of the predetermined position (for example, correction position). According to this, it is possible to move the position of the indicator in conjunction with the predetermined position. As a result, the user is able to easily grasp the state of image blur correction (activated or not) and the movement of the imaging device for activating or deactivating image blur correction from the positional relationship between the outer edge and the indicator of the auxiliary information.

Further, in this case, the control means (for example, display control unit 180) causes the display device (for example, display unit 340) to display the image (for example, zoom image) generated based on the cut-out region and the auxiliary information (for example, guide indicator). According to this, the user is able to confirm the image and the auxiliary information via the display device. As a result, the user is able to adjust the movement of the imaging device while viewing the auxiliary information. As a result, it is possible to more easily and properly acquire the image generated based on the cut-out region intended by the user.

Here, the image (for example, zoom image) generated based on the cut-out region and the auxiliary information (for example, guide indicator) are not necessarily displayed on the display device together. For example, it is possible to display them at different timings by switching display, display them on different screens, or the like.

Further, in this case, the control means (for example, display control unit 180) is capable of performing the notification during zoom photography (for example, during digital zoom photography). According to this, the various effects described above become more remarkable by performing the notification during zoom photography.

### EXAMPLE

Next, examples of a terminal, an electronic device (electronic equipment), and an information processing device to which the above-described image processing device 1 is applied or which are provided with the above-described image processing device 1 will be described. Here, a smartphone, which is a type of mobile phone with a camera function (with an imaging function), will be described as an example. However, it goes without saying that the examples to which the present invention can be applied are not limited thereto.

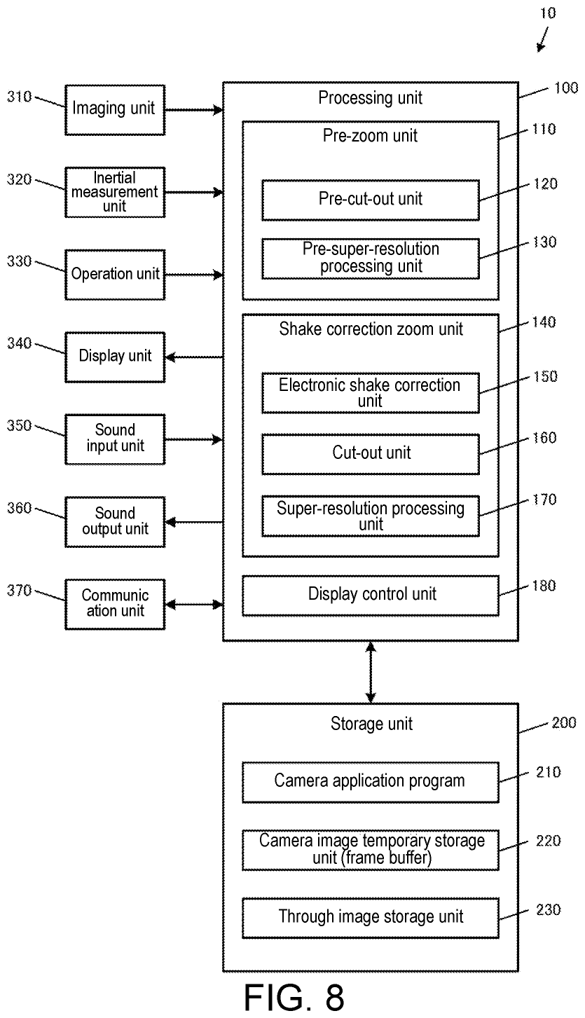

FIG. 8 is a diagram showing an example of the functional configuration of a smartphone 10. The smartphone 10 includes, for example, a processing unit 100, a storage unit 200, an imaging unit 310, an inertial measurement unit 320, an operation unit 330, a display unit 340, a sound input unit 350, a sound output unit 360, and a communication unit 370.

The processing unit 100 is a processing device that comprehensively controls each unit of a video editing PC 10 according to various programs such as a system program stored in the storage unit 200 and performs various types of processing related to video editing processing, and has processors such as CPU, GPU, and DSP, and integrated circuits such as ASIC.

The processing unit 100 has a pre-zoom unit 110, a shake correction zoom unit 140, and a display control unit 180 as main functional units. The pre-zoom unit 110 has, for example, a pre-cut-out unit 120 and a pre-super-resolution processing unit 130 as functional units thereof. The shake correction zoom unit 140 has, for example, an electronic shake correction unit 150, a cut-out unit 160, and a super-resolution processing unit 170 as functional units thereof. These functional units respectively correspond to the functional units included in the image processing device 1 of FIG. 1.

The storage unit 200 is a storage device including volatile or non-volatile memories such as ROM, EEPROM, flash memory, and RAM, hard disk devices, etc.

The storage unit 200 stores, for example, a camera application program 210, a camera image temporary storage unit 220, and a through image storage unit 230.

The camera application program 210 is a program to be read by the processing unit 100 and executed as camera application processing.

The camera image temporary storage unit 220 is, for example, a buffer (frame buffer) in which an image (image sensor image) captured by the imaging unit 310 and an output image (pre-zoom image) of the pre-zoom unit 110 are stored.

The through image storage unit 230 is, for example, imaged data (video data) in which the through image output from the display control unit 180 is stored (recorded).

The through image storage unit 230 may be saved in an external storage device (not shown) connected via the communication unit 370 (for example, NAS (Network Attached Storage) or the like).

The imaging unit 310 is an imaging device configured to capture an image of any scene, and includes an imaging element (semiconductor element) such as a CCD (Charge Coupled Device) image sensor and a CMOS (Complementary MOS) image sensor. The imaging unit 310 forms an image of the light emitted from an object to be imaged on a light-receiving plane of the imaging element by a lens (not shown), and converts the brightness of the light of the image into an electrical signal by photoelectric conversion. The converted electrical signal is converted into a digital signal by an A/D (Analog Digital) converter (not shown) and output to the processing unit 100.

The inertial measurement unit 320 includes, for example, a gyro sensor that detects the angular velocity around three axes (pitch, roll, and yaw) and an acceleration sensor that detects the inertial force in the axial directions of three axes (pitch, roll, and yaw). The detection result of the inertial measurement unit 320 is output to the processing unit 100 as needed.

The operation unit 330 includes input devices such as an operation button and an operation switch for the user to perform various operational inputs to the smartphone 10. Further, the operation unit 330 has a touch panel (not shown) configured integrally with the display unit 340, and this touch panel functions as an input interface between the user and the smartphone 10. An operation signal according to the user's operation is output to the processing unit 100 from the operation unit 330.

The display unit 340 is a display device including an LCD (Liquid Crystal Display), an OELD (Organic Electro-luminescence Display), or the like, and performs various displays based on display signals output from the display control unit 180.

The sound input unit 350 is a sound input device including a microphone, an A/D converter, etc., and performs various sound inputs based on sound input signals input to the processing unit 100.

The sound output unit 360 is a sound output device including a D/A converter, a speaker, etc., and performs various sound outputs based on sound output signals output from the processing unit 100.

The communication unit 370 is a communication device for transmitting and receiving information used inside the device to and from an external information processing device. Various systems are applicable as the communication system of the communication unit 370, such as a form of wired connection via a cable conforming to a predetermined communication standard such as Ethernet and USB (Universal Serial Bus), a form of wireless connection using wireless communication technology conforming to a predetermined communication standard such as Wi-Fi (registered trademark) and 5G (fifth generation mobile communication system), and a form of connection using short-range wireless communication such as Bluetooth (registered trademark).

The processing unit 100 of the smartphone 10 performs image capturing processing according to the camera application program 210 stored in the storage unit 200.

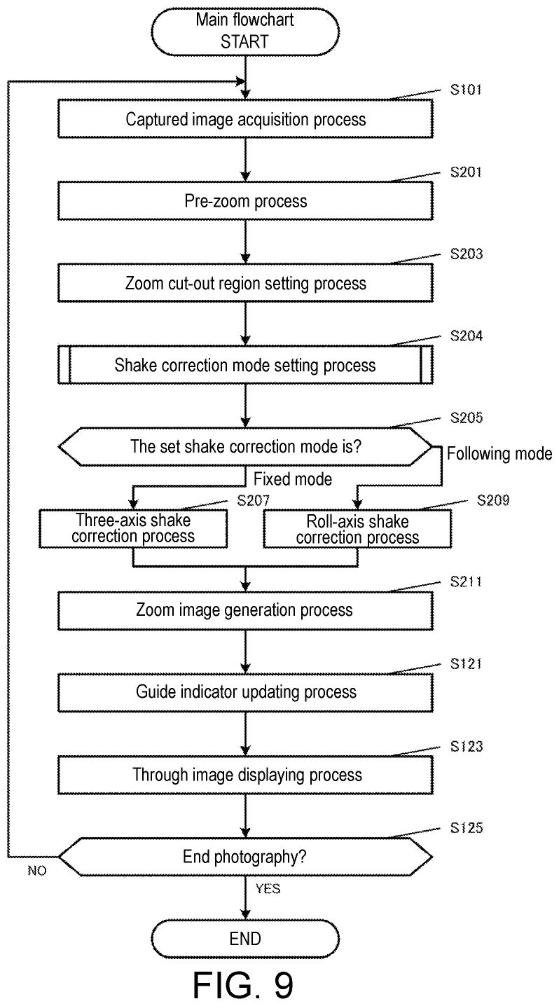

FIG. 9 is a flowchart showing an example of the procedure of image capturing processing in this embodiment.

When the pre-zoom unit 110 receives an image sensor image captured by the imaging unit 310 (S101), for example, a pre-zoom image is output according to the steps of S103 to S105 in FIG. 2 (S201).

When receiving the pre-zoom image as input, the shake correction zoom unit 140 performs a zoom cut-out region setting process (S203). Specifically, for example, according to the steps of S107 to S111 in FIG. 2, the pre-correction cut-out region, shake correction conversion, and correction vector C are calculated.

In the step of S109 in FIG. 2, the shake correction zoom unit 140 can, for example, calculate the shake correction conversion for three-axis (pitch, roll, and yaw) shake correction. This is because, in the case of telephoto-imaging a distant view, the translation of the imaging unit 310 has less effect on the shake correction result than the rotation of the imaging unit 310 around the three axes. Therefore, the computational cost for processing the shake correction conversion of five-axis shake correction that includes translation does not match the computational cost for processing the shake correction conversion of three-axis shake correction that can be calculated at high speed using quaternions.

Further, as for the correction around the roll axis, in order to prevent the post-correction cut-out region from continuing to tilt, horizontal correction may be forcibly performed if a fixed ratio is exceeded.

Besides, the shake correction conversion for five-axis shake correction may be calculated depending on the positional relationship between the imaging target and the smartphone 10.

Next, the shake correction zoom unit 140 executes a shake correction mode setting process (S204).

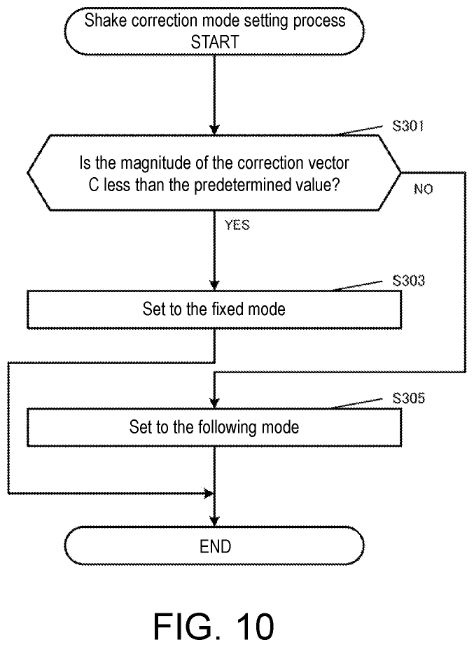

FIG. 10 is a flowchart showing an example of the procedure of the shake correction mode setting process.

First, the shake correction zoom unit 140 determines whether the magnitude of the calculated correction vector C (for example, L2 norm) is smaller than the predetermined value “R” of the shake correction condition (less than the predetermined value) (S301).

In this step, the shake correction zoom unit 140 may determine whether the magnitude of the correction vector C is equal to or less than the predetermined value “R” of the shake correction condition.

If the magnitude of the correction vector C is less than the predetermined value “R” (S301: YES), the shake correction zoom unit 140 sets the shake correction mode to “fixed mode” (S303). Here, the fixed mode is, for example, an imaging mode for tracking the imaging target within the zoom cut-out region and, as a result, suppressing changes in the zoom image (for example, shaking due to camera shake).

In order to notify the user of the smartphone 10 that the shake correction mode is the fixed mode, the shake correction zoom unit 140 may, for example, cause the sound output unit 360 to output a voice of “shake correction is on.” This voice may be output only when the shake correction mode one frame before is a following mode. In addition, the sound output unit 360 may output a predetermined sound other than the voice associated with the fixed mode.

If the magnitude of the correction vector C is equal to or greater than the predetermined value “R” (S301: NO), the shake correction zoom unit 140 sets the shake correction mode to “following mode” (S303). Here, the following mode is, for example, an imaging mode for following the change in the orientation of the imaging unit 310 and changing the imaging target that fits within the zoom cut-out region to, as a result, switch the target to be imaged as the zoom image.

In order to notify the user of the smartphone 10 that the shake correction mode is the following mode, the shake correction zoom unit 140 may, for example, cause the sound output unit 360 to output a voice of “shake correction is off.” This voice may be output only when the shake correction mode one frame before is the fixed mode. In addition, the sound output unit 360 may output a predetermined sound other than the voice associated with the following mode.

Furthermore, the shake correction zoom unit 140 may, for example, cause the sound output unit 360 to output a pin sound such as “beep-beep” according to the magnitude of the correction vector C. For example, the greater the magnitude of the correction vector C, the shorter the time interval at which the pin sound is produced, and when the magnitude of the correction vector C is equal to or greater than the predetermined value “R,” the pin sound can be changed to a continuous sound such as “peep.”

In addition, the shake correction zoom unit 140 may, for example, cause the sound output unit 360 to output so that the pin sound becomes louder as the magnitude of the correction vector C increases. In this case, the pin sound can be set to reach the set maximum volume when the magnitude of the correction vector C is equal to or greater than the predetermined value “R.”

Further, the shake correction zoom unit 140 may change the flashing mode of a notification lamp (not shown) of the smartphone 10 instead of the pin sound.

Returning to FIG. 9, the shake correction zoom unit 140 determines whether the set shake correction mode is the fixed mode or the following mode (S205).

If the set shake correction mode is the fixed mode (S205: fixed mode), the shake correction zoom unit 140 performs a three-axis shake correction process (S207). Specifically, for example, three-axis shake correction conversion is applied to the pre-correction cut-out region to set the zoom cut-out region.

If the set shake correction mode is the following mode (S205: following mode), the shake correction zoom unit 140 performs a roll-axis shake correction process (S209). Specifically, for example, one-axis shake correction conversion around the roll axis is applied to the pre-correction cut-out region to set the zoom cut-out region.

In the following mode, the shake correction zoom unit 140 outputs, for example, the correction vector C of the previous frame (that is, the correction vector C based on the cut-out region before the shake correction) to the display control unit 180. This is because one-axis shake correction conversion around the roll axis has little effect on the frame-to-frame variation of the correction vector C.

If the set shake correction mode is the following mode (S205: following mode), the shake correction zoom unit 140 may set the pre-correction cut-out region directly as the zoom cut-out region. In this case, the shake correction process is not performed in the shake correction zoom unit 140.

Then, the shake correction zoom unit 140 generates a zoom image according to the steps of S117 to S119 in FIG. 2, for example (S211).

When the shake correction zoom unit 140 notifies the shake correction mode with the sound output from the sound output unit 360, the display control unit 180 may not execute the step of S121, and output the zoom image directly as the through image in the step of S123.

In addition, the display control unit 180 may display the zoom image and the guide indicator on individual display units 340 without combining them in the step of S123. In this case, the display control unit 180 can, for example, cause a first display unit (not shown) to display the zoom image and cause a second display unit (not shown) to display the guide indicator that includes the zoom position indicator indicated by a square, for example.

Furthermore, in the step of S123, the display control unit 180 may, for example, combine and display the zoom image and the guide indicator when display of the guide indicator is selected based on the user's operation on the operation unit 330.

Further, in the case where the zoom magnification of the zoom image (for example, “p×q” times) is selected based on the user's operation on the operation unit 330, the display control unit 180 may, for example, combine and display the zoom image and the guide indicator only when the zoom magnification is equal to or greater than a predetermined magnification, for example. Also, in this case, when the zoom magnification is lower than a predetermined magnification, the guide indicator may not be displayed in the through image. In other words, the notification may be performed when a predetermined condition is satisfied (the notification may not be performed when the predetermined condition is not satisfied).

### [Actions and Effects of the Example]

According to the smartphone 10 of this example, it is possible to achieve the same actions and effects as in the above-described embodiment.

Further, in the smartphone 10 of this example, the control means (for example, shake correction zoom unit 140) performs the notification by causing a sound output device (for example, sound output unit 360) to output, as a sound, guide information (for example, a voice of “shake correction is on”) which is based on the displacement (for example, correction vector C) and the set value (for example, predetermined value “R” of the shake correction condition) and is capable of specifying the range from which the cut-out region can be cut out while the shake correction is activated (for example, range that satisfies the shake correction condition). By adopting such a configuration, the user is able to easily grasp the state of image blur correction by listening to the guide information even in a situation where it is difficult to visually see the notification.

Further, in the smartphone 10 of this example, the control means (for example, shake correction zoom unit 140) changes a sound output mode (for example, time interval) of the guide information (for example, pin sound) based on the displacement (for example, correction vector C) and the set value (for example, predetermined value “R”). By adopting such a configuration, the user is able to easily and properly grasp whether it is the range from which the cut-out region can be cut out while the image blur correction is activated, by listening to the guide information.

Further, in the smartphone 10 of this example, the guide information includes a predetermined guide sound (for example, a pin sound and a continuous sound), and the control means (for example, shake correction zoom unit 140) changes the sound output mode of the guide sound based on the relationship between the magnitude of the displacement (for example, L2 norm of the correction vector C) and the set value (for example, predetermined value “R”). By adopting such a configuration, the user is able to more accurately grasp the state within the range from which the cut-out region can be cut out while the image blur correction is activated, by listening to the guide information. As a result, the user is able to adjust the movement of the imaging device while listening to the guide sound. As a result, it is possible to more easily and properly acquire the image generated based on the cut-out region intended by the user.

Further, in the smartphone 10 of this example, a setting means (for example, shake correction zoom unit 140) is further provided, which is capable of setting any one of a plurality of modes (for example, fixed mode and following mode) related to the image blur correction (for example, shake correction), and the correction means (for example, electronic shake correction unit 150) performs the image blur correction according to the mode set by the setting means. By adopting such a configuration, the correction means is capable of performing appropriate image blur correction according to the mode on the image based on the imaging performed by the imaging device.

Further, in the smartphone 10 of this example, the plurality of modes include at least a first mode (for example, fixed mode) in which the correction means (for example, electronic shake correction unit 150) performs the image blur correction by a first process (for example, three-axis shake correction process), and a second mode (for example, following mode) in which the correction means performs the image blur correction by a second process (for example, one-axis shake correction process) different from the first process or in which the correction means does not perform the image blur correction. By adopting such a configuration, the correction means is capable of performing strong image blur correction by the first process in the first mode, and performing weak image blur correction by the second process different from the first process or not performing image blur correction in the second mode, for the image based on imaging performed by the imaging device.

Further, in the smartphone 10 of this example, the control means (for example, shake correction zoom unit 140) controls the notification based on displacement (for example, correction position) of the cut-out region (for example, post-correction cut-out region) associated with movement of the imaging device (for example, imaging unit 310) and a set value (for example, predetermined value “R”) that defines a range in which the image blur correction is activated, and the setting means determines the mode to be set based on the displacement and the set value. By adopting such a configuration, it is possible to properly determine the mode in conjunction with the notification based on the displacement and the set value.

Further, in the smartphone 10 of this example, the control means (for example, shake correction zoom unit 140) performs the notification (for example, whether to emit a pin sound or a continuous sound) according to the mode set by the setting means (for example, shake correction zoom unit 140). By adopting such a configuration, the user is able to easily grasp the mode by the notification.

### Modified Example

Embodiments to which the present invention can be applied are not limited to the above embodiment. Modified examples will be described hereinafter.

### Modified Example without the Pre-Zoom Unit 110

In the above embodiment, the shake correction zoom unit 140 receives, as input, the pre-zoom image obtained by pre-enlarging (digitally zooming) the image sensor image, but the present invention is not limited thereto. For example, the shake correction zoom unit 140 may acquire the image sensor image from the imaging unit 310. In this case, the shake correction zoom unit 140 may execute various processes using the image sensor image as the pre-zoom image.

By adopting such a configuration, when obtaining a zoom result of the same magnification, the predetermined value “R” of the shake correction condition can be made larger compared to a case where the pre-zoom image is used as input. That is, the region which allows shake correction is expanded, making it possible to improve the performance of shake correction. In addition, since the image cut-out and super-resolution processing are performed only once, deterioration of the zoom image is avoided.

However, if the image sensor image is directly input to the shake correction zoom unit 140, there is a possibility that the zoom cut-out region may be far away from the central part of the image sensor image, and it may be difficult for the operator of the imaging unit 310 to adjust the zoom image to the intended composition. Further, when estimating inertial information from the image sensor image group input to the shake correction zoom unit 140, since a wider range of images is input, plane approximation becomes more difficult, and the accuracy of estimating inertial information may decrease. Therefore, it may be considered desirable to receive the pre-zoom image obtained by pre-enlarging (digitally zooming) the image sensor image as input especially when the user wishes to enlarge the image sensor image to a high magnification (for example, a magnification of “4 times or more”).

When the image sensor image is input by setting the zoom magnification of the shake correction zoom unit 140 to equal magnification (however, the zoom image is one size smaller than the image sensor image), the guide indicator can also be used as an indicator that indicates the crop position when electronic shake correction is applied to the image sensor image.

### Modified Example in which the Post-Correction Cut-Out Region Deviates from the Pre-Zoom Image

In the above embodiment, the predetermined value “R” of the shake correction condition is set so that the post-correction cut-out region does not deviate from the pre-zoom image, but the present invention is not limited thereto. For example, the predetermined value “R” of the shake correction condition may be set so that a part of the post-correction cut-out region protrudes outside the pre-zoom image.

In this case, for the post-correction cut-out region that protrudes outside, for example, the pre-zoom unit 110 may again change the pre-cut-out region from the image sensor image to generate a second pre-zoom image, and crop from the post-correction cut-out region using the second pre-zoom image as input.

In addition, according to the shake correction method disclosed in Japanese Patent No. 6682559, for example, the shake correction process may also be performed by adding an image generation unit to the shake correction zoom unit 140 to generate an image of the region corresponding to the post-correction cut-out region that protrudes outside.

### Modified Example 1 for the Zoom Position Indicator

In the above embodiment, the zoom position indicator is shown as a black square, but the present invention is not limited thereto. For example, an icon indicating the state of shake correction may be arranged within the zoom position indicator.

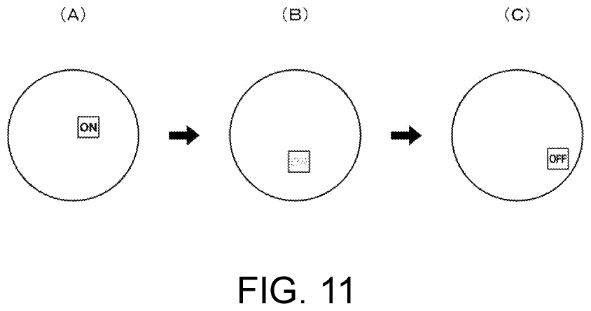

FIG. 11 is a diagram showing another example of the guide indicator shown in (A) of FIG. 4 to (C) of FIG. 5. In (A) of FIG. 11, which corresponds to (A) of FIG. 4, the zoom position indicator is, for example, a square icon indicated by the letters “ON.” This zoom position indicator explicitly indicates with the letters “ON” that the shake correction is activated.

In (B) of FIG. 11, which corresponds to (B) of FIG. 5, based on that the zoom position indicator is closer to the outer edge than in (A) of FIG. 11, the letters “ON” in the icon are lighter than in (A) of FIG. 11.

In (C) of FIG. 11, which corresponds to (C) of FIG. 5, since the shake correction is switched to be deactivated, the zoom position indicator is, for example, a square icon indicated by the letters “OFF.”

Besides, for example, the letters “ON” of the zoom position indicator may be blinked, and the blinking interval may be shortened as the zoom position indicator gets closer to the outer edge of the guide indicator.

In addition, the letters “ON” and “OFF” may be arranged and displayed outside the outer edge of the guide indicator.

Moreover, the shape of the zoom position indicator is not limited to a square. The shape of the zoom position indicator may be, for example, a circle, a triangle, or an arrow starting from the center of the guide indicator.

Furthermore, the display color of the zoom position indicator may be changed as the zoom position indicator moves away from the center of the outer edge of the guide indicator. For example, the display color of the zoom position indicator may be “blue” near the center, and may become “red” as the zoom position indicator gets closer to the outer edge. Further, the display color of the outer edge of the guide indicator may be changed depending on whether shake correction is activated or deactivated.

In the image processing device (for example, image processing device 1) of this modified example, the control means (for example, display control unit 180) changes the display mode of the auxiliary information (for example, guide indicator) based on the displacement (for example, correction vector C) and the set value (for example, predetermined value “R” of the shake correction condition). According to this, the user is able to more easily grasp whether the image blur correction is activated by confirming the display mode of the auxiliary information.

Further, in this modified example, the control means (for example, display control unit 180) changes the display mode of the indicator (for example, zoom position indicator) based on the relationship between the magnitude of the displacement (for example, magnitude of the correction vector C) and the set value (for example, predetermined value “R”). According to this, by confirming the display mode of the indicator, the user is able to easily and properly grasp the degree of tolerance related to movement of the imaging device outside the range where image blur correction is activated, even without checking the relationship between the outer edge of the auxiliary information and the indicator.

### Modified Example 2 for the Zoom Position Indicator

In the above embodiment, the zoom position indicator is arranged at the ending point of the correction vector C, but the present invention is not limited thereto. For example, the zoom position indicator may be arranged at a position point-symmetrical to the ending point of the correction vector C with respect to the center of the outer edge of the guide indicator.

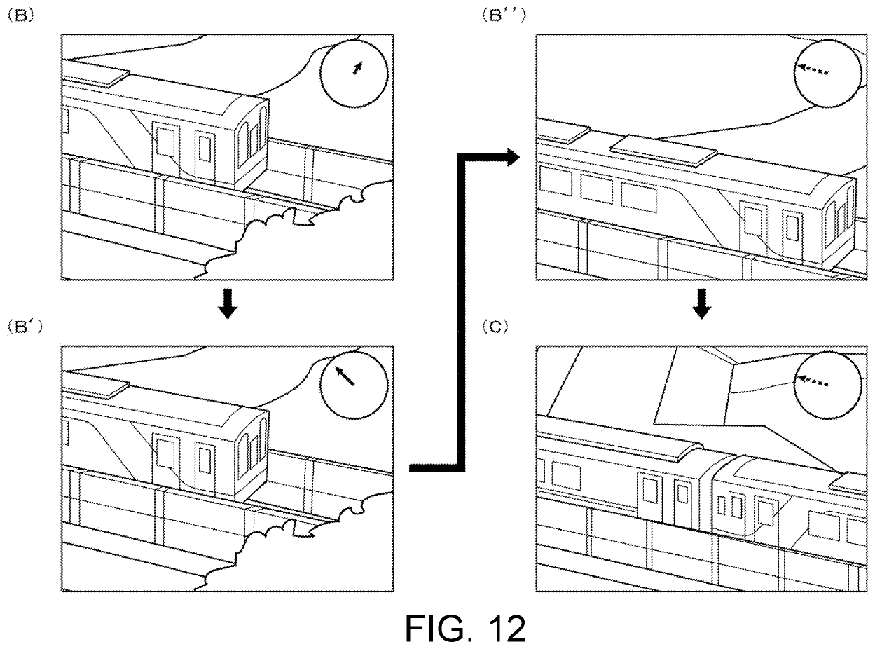

FIG. 12 is another example of FIG. 7 in this case where the zoom position indicator is an arrow. The respective zoom images in (B) of FIG. 12 to (C) of FIG. 12, which are through images in the respective transition states, are similar to, for example, (B) of FIG. 7 to (C) of FIG. 7.

While the zoom position indicator in (B) of FIG. 7 is arranged on the lower left side near the center, in the guide indicator of (B) of FIG. 12, the zoom position indicator is indicated by an arrow that starts at the center of the outer edge and ends on the upper right side near the center. The same applies to other transition states. Since the orientation of this arrow matches the change in the orientation of the imaging unit 310 (camera movement direction), the operator of the imaging unit 310 is able to more intuitively grasp the state of shake correction.

In addition, in (B″) of FIG. 12 and (C) of FIG. 12, based on that the tip of the zoom position indicator comes into contact with the outer edge and the shake correction is deactivated, the arrow, for example, blinks so as to flow from the center toward the outer edge. This animation effect allows the operator of the imaging unit 310 to easily grasp that the imaging target to be captured as the zoom image from the full view is being changed in the direction of flow of the arrow.

### Modified Example for the Guide Indicator

In the above embodiment, the outer edge of the guide indicator is circular, but the present invention is not limited thereto. For example, the outer edge may be rectangular.

In this case, for example, a short-diameter region having the same aspect ratio as the pre-zoom image is drawn as the outer edge for the guide indicator. Then, the correction vector C may be used without being normalized with respect to the aspect ratio of the pre-zoom image.

Nevertheless, it is not necessary to draw the guide indicator collectively in a part (for example, upper left) in the through image. For example, a zoom position indicator in eight directions may be displayed according to the orientation of the correction vector C on four sides and four corners in the through image, and the density and color of the zoom position indicator may be changed according to the magnitude of the correction vector C.

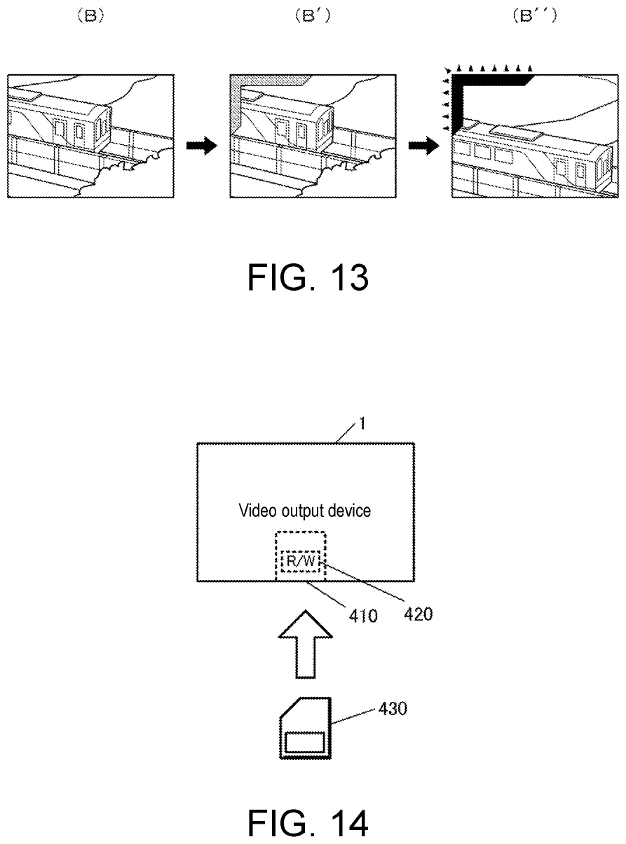

FIG. 13 shows an example of transition of the through image in this case. The respective zoom images in (B) of FIG. 13 to (B″) of FIG. 13, which are through images in the respective transition states, are similar to, for example, (B) of FIG. 7 to (B″) of FIG. 7.

In (B) of FIG. 13, the zoom position indicator is not displayed at the four corners of the through image because the magnitude of the correction vector C is small.

In (B′) of FIG. 13, as the magnitude of the correction vector C increases, an L-shaped indicator is displayed on the upper left of the through image, which is a corner symmetrical to the orientation of the correction vector C. Since the magnitude of the correction vector C is, for example, about “R/2” with respect to the predetermined value “R” of the correction condition, the L-shaped indicator is displayed, for example, in gray.

In (B″) of FIG. 13, the L-shaped indicator is displayed, for example, in black based on that the magnitude of the correction vector C is equal to or greater than the predetermined value “R.” In addition, the L-shaped indicator is blinking in order to more strongly notify that the shake correction is deactivated.

When displaying indicators only at the four corners of the through image, for example, indicators on the upper left and lower left may be displayed as indicators corresponding to camera movement to the left. Further, when displaying indicators only on the four sides of the through image, for example, indicators on the left side and the upper side may be displayed as indicators corresponding to camera movement to the upper left.

In addition, the mode of shake correction in the example may be, for example, combined with the through image as character information (for example, “fixed mode”). In this case, for example, in the fixed mode, the greater the magnitude of the correction vector C, the faster the character information blinks, and in the following mode, the character information may continue to light up. When the character information is combined, the zoom position indicator may not be displayed.

### <Mode of Notification>

In the present invention, the type and mode of the notification (notification related to the range from which the cut-out region can be cut out while the image blur correction is activated by the correction means) are not limited to display and sound output. For example, vibration, light emission, and the like may also be included.

### <Configuration of Image Processing Device>

In the present invention, for example, any of the following configurations can be applied as the configuration of the image processing device 1.
(1) The pre-zoom unit 130 performs digital zooming, and the shake correction zoom unit 140 further performs digital zooming with shake correction.
(2) The pre-zoom unit 130 performs digital zooming, and the shake correction zoom unit 140 performs only shake correction.
(3) Without using the pre-zoom unit 130, the shake correction zoom unit 140 performs digital zooming with shake correction.
(4) Without using the pre-zoom unit 130, the shake correction zoom unit 140 performs only shake correction.
   When the shake correction zoom unit 140 performs only shake correction, a configuration is conceivable in which the shake correction zoom magnification is set to “1” times and the super-resolution processing in the super-resolution processing unit 170 is not performed, for example.

### <Various Devices>

In the above example, the present invention is applied to an image processing device, a terminal, an electronic device (electronic equipment), and a smartphone, which is an example of an information processing device, but the present invention is not limited thereto. The present invention is applicable to various devices such as a digital telescope, a video camera, a still camera, a tablet terminal, and a wearable terminal such as smart glasses.

### <Recording Medium>

In the above embodiment, various programs and data related to image processing are stored in the storage unit 200, and the image processing in each of the above embodiments is realized by the processing unit reading and executing these programs. In this case, the storage unit of each device may include a non-transitory tangible recording medium (recording media, external storage device, storage medium) such as memory card (SD card), compact flash (registered trademark) card, memory stick, USB memory, CD-RW (optical disk), and MO (magneto-optical disk) in addition to internal storage devices such as ROM, EEPROM, flash memory, hard disk, and RAM, and the various programs and data described above may be stored in these recording media. These storage media are examples of non-transitory computer-readable recording media (storage media).

FIG. 14 is a diagram showing an example of the recording medium in this case. In this example, the image processing device 1 is provided with a card slot 410 for inserting a memory card 430, and a card reader/writer (R/W) 420 for reading information stored on or writing information to the memory card 430 inserted in the card slot 410.

The card reader/writer 420 performs an operation of writing the programs and data recorded in the storage unit (not shown) to the memory card 430 under the control of the processing unit. The programs and data recorded on the memory card 430 are configured to be read by an external device other than the image processing device 1 to implement the image processing in the above embodiment in the external device.

In addition, the above recording medium is applicable to various devices such as a terminal (smartphone), an image processing device, an electronic device (electronic equipment), and an information processing device including the image processing device 1 described in the above example.

### REFERENCE SIGNS LIST

1 image processing device
10 smartphone
110 pre-zoom unit
120 pre-cut-out unit
130 pre-super-resolution processing unit
140 shake correction zoom unit
150 electronic shake correction unit
160 cut-out unit
170 super-resolution processing unit
180 display control unit

1. A control device, comprising:
a controller performing control to display a zoom image based on an image captured by an imaging device on a display device, display an outer edge on the display device, and display an indicator at a position surrounded by the outer edge,
wherein a degree of tolerance related to movement of the imaging device or a subject up to a range where image blur correction is deactivated increases as a shortest distance between the outer edge and the indicator increases.

2. The control device according to claim 1, wherein the controller is capable of changing the position of the indicator in a region surrounded by the outer edge.

3. The control device according to claim 2, wherein the outer edge is circular or rectangular,
the indicator is arranged at a point that is farther from a center of the outer edge as displacement of a cut-out region based on the image captured by the imaging device becomes larger with respect to a center point of the image based on the imaging, and
the point comes into contact with the outer edge when an amount of displacement of the cut-out region reaches a predetermined amount.

4. The control device according to claim 1, wherein the indicator comprises a string of characters.

5. The control device according to claim 4, wherein the controller changes a density, a color, or a blinking interval of the string of characters according to the shortest distance between the outer edge and the indicator.

6. The control device according to claim 1, wherein the indicator comprises an arrow.

7. The control device according to claim 6, wherein the shortest distance between the outer edge and the indicator is a shortest distance between the outer edge and a tip of the arrow.

8. The control device according to claim 7, wherein a starting point of the arrow is the center of the outer edge, an orientation of the arrow coincides with a displacement direction of the cut-out region based on the image captured by the imaging device, and a length of the arrow increases as the amount of displacement of the cut-out region increases.

9. The control device according to claim 1, wherein the controller performs the image blur correction according to a mode set from a plurality of modes related to the image blur correction.

10. The control device according to claim 9, wherein the plurality of modes comprise at least a first mode in which the image blur correction is performed by a first process, and a second mode in which the image blur correction is performed by a second process different from the first process or in which the image blur correction is not performed, and
the controller displays the indicator in a first form when in the first mode, and displays the indicator in a second form different from the first form when in the second mode.

11. The control device according to claim 10, wherein the indicator comprises a string of characters, and
the string of characters differs between the first form and the second form.

12. The control device according to claim 10, wherein the indicator is in a form of an arrow, and
a line type of the arrow differs between the first form and the second form.

13. The control device according to claim 1, wherein the controller performs control to display the indicator during zoom photography.

14. A control device, comprising:
a controller capable of displaying a zoom image based on an image captured by an imaging device on a display device and displaying an indicator at an edge of the zoom image, and capable of changing a density of the indicator,
wherein a degree of tolerance related to movement of the imaging device or a subject up to a range where image blur correction is deactivated decreases as the density increases.

15. The control device according to claim 14, wherein the controller performs the image blur correction according to a mode set from a plurality of modes related to the image blur correction,
the plurality of modes comprise at least a first mode in which the image blur correction is performed by a first process, and a second mode in which the image blur correction is performed by a second process different from the first process or in which the image blur correction is not performed,
the controller displays the indicator in a first form when in the first mode, and displays the indicator in a second form different from the first form when in the second mode, and
the first form and the second form are lighting or blinking forms.

16. (canceled)

17. (canceled)

18. A non-transient computer-readable recording medium, recording a program, causing a computer to:
display a zoom image based on an image captured by an imaging device on a display device;
display an outer edge on the display device; and
display an indicator at a position surrounded by the outer edge,
wherein a degree of tolerance related to movement of the imaging device or a subject up to a range where image blur correction is deactivated increases as a shortest distance between the outer edge and the indicator increases.

19. The control device according to claim 14, wherein the controller performs control to display the indicator during zoom photography.
